(19) United States
(12) Patent Application Publication
(10) Pub. No.: US 2011/0234850 A1
(43) Pub. Date: Sep. 29, 2011

(54) SantaCam

(75) Inventors: Brad Keller, Flower Mound, TX (US); Gary Fowler, Flower Mound, TX (US)

(73) Assignee: KF PARTNERS LLC, Flower Mound, TX (US)

(21) Appl. No.: 12/795,598

(22) Filed: Jun. 7, 2010

Related U.S. Application Data
(60) Provisional application No. 61/298,823, filed on Jan. 27, 2010.

(51) Int. Cl. H04N 5/76

(52) U.S. Cl. 348/231.7; 348/E05.031

(57) ABSTRACT

A camera for producing a taken picture that is seen jointly with fictional characters contained digitally and superimposing said figure in the picture overlapped with owner's location. The camera contains a Memory card with multiple fictional character figures such as Santa Claus, Easter Bunny, etc., in various positions, poses and sizes which the operator can choose for the picture that best fits the operator's home or location. The digital picture frame is formed by a series of picture options using multiple fictional characters each being pre-photographed and uploaded to the memory card to create a latent image thereon of a character at a predetermined position within the digital frame. Parental control option switches the camera to manual mode. When, therefore, the shutter is actuated by the operator in manual mode, a picture is taken in which the location appears in juxtaposition to the fictional character.

I claim benefit of a provisional patent application, U.S. 61/298,823, filed on Jan. 27, 2010.

A High Speed Digital Motion Detector Camera that carries multiple loaded three dimensional images of fictional characters that can be manipulated and located within the camera frame to be in juxtaposition to the owners own home or background location.

### BACKGROUND OF THE INVENTION

1. Field of Invention

This invention relates generally to photography, and in particular to a technique and a camera based thereon in which the camera is digitally loaded with fictional characters whose successive light-sensitive images contain latent images thereon of fictional characters and a locational background image in which LCD Screen frames are overlapping digital images therein corresponding to the latent images, whereby when fictional characters are then seen in the LCD Screen of the camera and photographed, the now chosen by operator fictional character appears in the resultant pictures in juxtaposition to the location so as to establish an apparent relationship there between.

2. Status of Prior Art;

A camera consists essentially of a light-proof enclosure housing a light-sensitive digital image and provided with a lens to admit light and focus it on the digital image. In a standard commercial camera, an adjustable diaphragm is included as well as a shutter and a LCD Screen. The diaphragm can be adjusted to vary the diameter of the lens aperture and hence the amount of admitted light. The shutter acts to control the length of time the digital image is exposed to light.

Today, characters such as Santa Claus hold great fascination for children. While Saint Nicholas was originally portrayed wearing bishop's robes, today Santa Claus is generally depicted as a plump, jolly, white-bearded man wearing a red coat with white collar and cuffs, white-cuffed red trousers, and black leather belt and boots. This image became popular in the United States and Canada in the 19th century due to the significant influence of caricaturist and political cartoonist Thomas Nast. This image has been maintained and reinforced through song, radio, television, and films. In the United Kingdom and Europe, he is often depicted in a manner identical to the American Santa Claus, but he is commonly called Father Christmas. Thus Santa Claus and other fictional character such as the Easter Bunny are internationally known characters.

The line of demarcation between reality and imagination is not sharply drawn in a typical child. Fictional characters such as Santa Claus, the Easter Bunny, and the Tooth Fairy are seen in movies, shopping malls and books but a child does not see the fictional characters in their homes.

In my above-identified copending application, there is disclosed a photographic technique for producing a picture utilizing a camera and Memory card for producing a taken picture that is seen jointly with a fictional character contained on the Memory card and superimposing background image of the home or location in the picture.

The technique comprising inserting a Memory card loaded with various fictional characters in a camera having a LCD screen. The Memory card with a series of pre-loaded images of fictional characters would be placed in each picture frame chosen by the operator containing a latent image of a character at a predetermined position within the frame, said memory card having a digital menu guide which is interposed between the LCD Screen and the eye of the operator and whose successive LCD Screen frames are constituted by overlapping background location images corresponding to the latent images on the picture frames.

Taking pictures with the camera of a scene to expose the successive picture frames so that in each picture frame a latent image seen through the LCD screen appears in juxtaposition with that of the latent image of the fictional character in the picture frame in a position which is then completely digitally married. Developing and printing now married pictures from the memory card to provide pictures in each of which the fictional character appears in the taken picture.

### SUMMARY OF INVENTION

The primary purpose of this invention is to provide a camera for producing a taken picture that is seen jointly with fictional characters contained digitally and superimposing said figure in the picture overlapping within the background existing image.

Specifically, the camera contains a Memory card with multiple fictional character figures in various positions, sizes, and poses which the operator can choose for the picture that best fits the operator's home or location. The digital picture frame is formed by a series of picture options using multiple fictional characters each being prepositioned to create a latent image thereon of a character at a predetermined position within the digital frame. The digital menu track has a series of fictional characters each having a unique position, size, and pose image thereon corresponding to the operator's locational image to the adjacent digital picture frame. The camera includes an exposure section provided with a lens and a shutter, the digital picture image being advanceable through this section. And it also includes a LCD Screen through which is advanceable through the digital image track. When the camera is set for taking a picture with the motion detector option, parents can display to their children the camera is ready and in position to capture the fictional character once activated. When the camera is set for taking a picture in parent mode or manual mode, the parents choose through various fictional characters positions, sizes, and poses that best fits the owner's particular home or location. Once a fictional character image is selected, the owner uses the overlapping feature to place the image over the existing background location image for exposure and the operator can then view through the LCD Screen section the picture that is to be taken in juxtaposition to the digital fictional character image and background location image on the corresponding LCD Screen frame. When, therefore, the shutter is actuated by the operator, a picture is taken in which the location appears in juxtaposition to the fictional character.

These fictional characters are stored in a memory card in the camera for producing pictures in a scene so the fictional characters and background location is visualized jointly with a fictional character in such a way as to establish an apparent relationship there between. Said camera being loaded with a digital menu guide having a digital picture whose series of fictional character images are displayed so that each picture frame contains a latent image of the fictional character at a predetermined position, said camera being provided with a LCD screen, including a lens and shutter means which said digital menu track is advanceable whereby when the shutter means of the camera is actuated to take a picture on a particular picture frame containing the chosen fictional character of a scene seen through the LCD screen, the picture frame is then overlapped with the background location transforming the fictional character as seen in juxtaposition in the scene.

### BRIEF DESCRIPTION OF DRAWINGS

For a better understanding of the invention as well as other objects and further features thereof, reference is made to the following detailed description to be read in conjunction with the accompanying drawings, wherein:

FIG. 1 illustrates the fictional character dial;

FIG. 2 Manual push button for picture taking;

FIG. 3 Flash;

FIG. 4 Parent control button which releases the ability to view fiction character options;

FIG. 5 Camera Lens;

FIG. 6 Motion Detection censor for Motion Detector Control Option;

FIG. 7 LCD Screen;

FIG. 8 Menu Option Buttons;

FIG. 9 Directional Option Buttons for choosing fictional character options.

### DESCRIPTION OF INVENTION

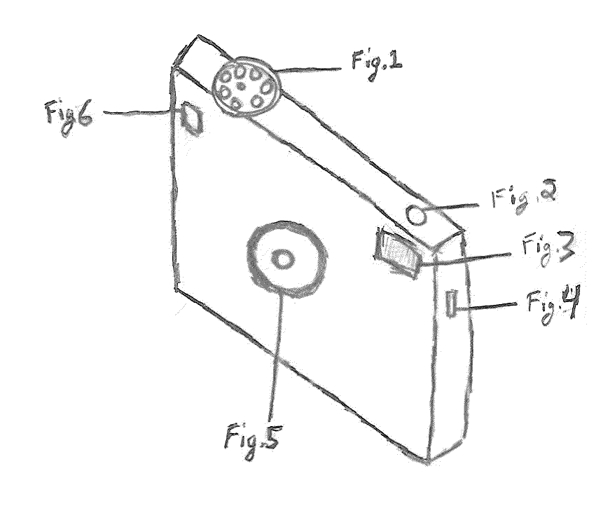

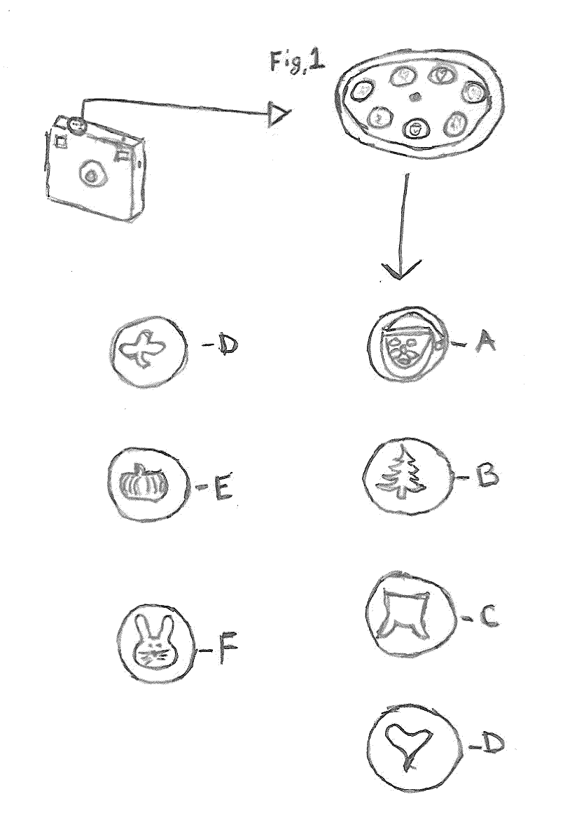

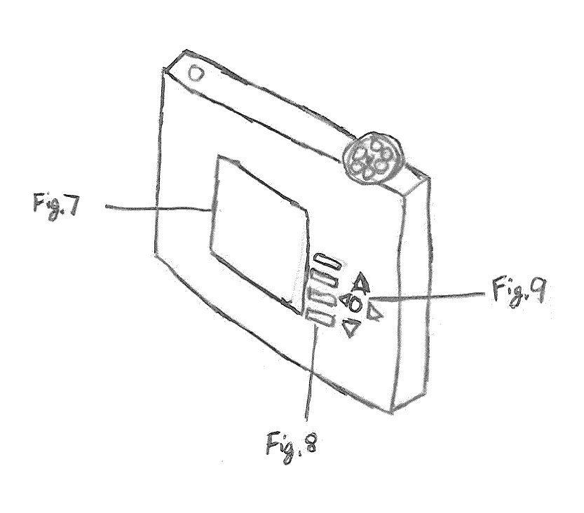

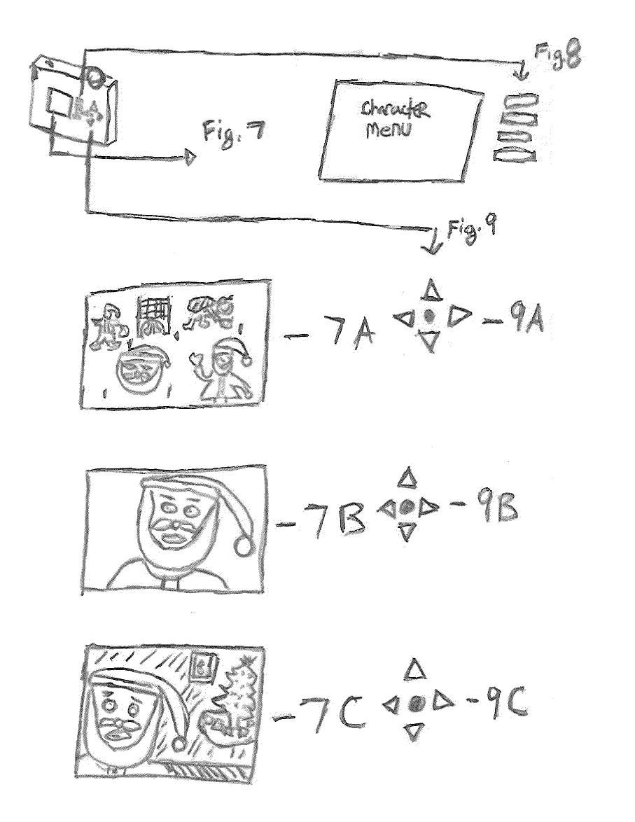

Referring now to FIG. 1, the fictional character dial contains 7 holiday character options. Once the dial is moved to the selected position, the fictional characters will appear based on the selected holiday button. Button A reveals a picture of Santa Claus. This particular button holds various positions, sizes, and poses of Santa Claus acquired from digitally enhanced green screen photographs minus the Chroma Key green screen elements giving the image a realistic appearance that can be overlapped into the existing background location. Option B button if selected gives further Christmas holiday options including an Elf, Snowman, Mrs. Claus, Reindeer, and Ghostly Santa Claus images. Option button C if selected provides multiple images of the Tooth Fairy in various shapes, sizes and positions. Option D if selected provides multiple images of Cupid for the Valentine's Day Holiday. Option E if selected provides multiple Leprechaun images that can be used during the St. Patrick Day Holiday. Option F if selected provides multiple images of the Easter Bunny that can be used during the Easter celebration. Illustrated in FIG. 2, this Manually pressed button will expose the lens FIG. 5 applying a digital image to the LCD FIG. 7; once engaged the Manual push button for taking pictures will automatically dismiss the motion detector option FIG. 6.

Illustrated in FIG. 4, the Parent Control button allows the fictional character content to become available using the menu buttons FIG. 8. Once the parent control button has been optioned, the menu pages FIG. 8 will display the currently highlighted fictional character button FIG. 1 option to be chosen on the LCD Screen FIG. 7. FIG. 7A demonstrates the multiple fictional character selections. By pressing the directional arrows FIG. 9, this allows the user to highlight the fictional character image desired. Using the center button on the directional arrows FIG. 9A allows the selected image to be displayed alone on the LCD Screen FIG. 9B. By using the menu buttons FIG. 8, the image is now transferred onto the existing background location FIG. 9C. The directions buttons FIG. 9 can now be used to adjust the image in juxtaposition to the background. Once the final selection has been made, the menu buttons FIG. 9 can be depressed to send the final selection to the memory storage.

Assuming a fictional character button option FIG. 1 contains 20 images of a given character and further assuming that the memory device is intended to establish a relationship between a character, such as Santa Claus or Easter Bunny, with a given background location or individual in different situations, then the character whose latent image is contained in each frame will be photographed in a different pose in each frame at a predetermined position within the frame.

For this purpose, the fictional character photographed is preferably not in two dimensional cartoon form, but is a three-dimensional real photographic image pre-produced, large scale effigy, so that his relationship with the location or individual appearing in the same photograph is more realistic;

While there has been shown and described a preferred embodiment of a photographic technique and a camera based thereon for producing pictures of individuals jointly with characters in accordance with the invention, it will be appreciated that many changes and modifications may be made therein without, however, departing from the essential spirit thereof.

1. A technique for producing digital photographic pictures in which fictional characters are in juxtaposition with a owners home or background location.
(a) This high speed motion detector digital camera is unique to a existing motion detector cameras due to the ability to manipulate a preprogrammed image with the owners existing home or background location. The ability to capture fictitious characters such as Santa Clause and the Easter Bunny, among others will enlighten the hearts of children around the world.
(b) Developing or printing these images from saved memory cards.
